(19) United States
(12) Patent Application Publication
(10) Pub. No.: US 2024/0084958 A1
(43) Pub. Date: Mar. 14, 2024

(54) TRIPOD SUPPORTING BASE

(71) Applicant: Daniel E. Bergan, Rochester, NY (US)

(72) Inventor: Daniel E. Bergan, Rochester, NY (US)

(21) Appl. No.: 18/512,777

(22) Filed: Nov. 17, 2023

Related U.S. Application Data
(63) Continuation of application No. PCT/US22/30054, filed on May 19, 2022.
(60) Provisional application No. 63/191,063, filed on May 20, 2021.
(60) Provisional application No. 63/308,886, filed on Feb. 10, 2022.

(51) Int. Cl. F16M 11/32; F16M 11/14; F16M 11/16

(52) U.S. Cl. CPC F16M 11/32; F16M 11/14; F16M 11/16; F16M 2200/024

(57) ABSTRACT

A tripod includes a base; an extension member; and a tripod leg attachment member. The tripod leg attachment member includes a tripod leg attachment interface configured to attach a tripod leg thereto and a plurality of tripod leg positioning interfaces configured to enable a tripod leg to be positioned at various different distinct angles with respect to the base.

### CROSS-REFERENCE TO RELATED APPLICATIONS

This application is a continuation of International Application No. PCT/US2022/030054, filed on May 19, 2022, which claims priority to U.S. Provisional Patent Application No. 63/191,063, filed on May 20, 2021, and U.S. Provisional Patent Application No. 63/308,886, filed on Feb. 10, 2022. The entire disclosures of the above-identified applications are hereby incorporated by reference.

### TECHNICAL FIELD

The present invention is directed to a tripod supporting base. More particularly, the present invention is directed to a tripod supporting base that includes a mounting platform; a plurality of leg attachment modules connected to the mounting platform wherein the leg attachment module is configured to enable a detachable leg to be attached at one of a plurality of angles.

### BACKGROUND

FIG. 1 shows a conventional tripod arrangement wherein a camera 20 mounted upon a positionable ball head 10 having a positioning clamp lever 11. The positionable ball head 10 is mounted upon a tripod base 35 to which tripod legs 30 are connected.

It is noted that the tripod legs 30 are connected at a predetermined angle and may be telescopic to enable the adjustment of the height of the tripod base above the surface upon which the tripod is placed.

A drawback of the conventional tripod arrangement is that when the tripod is not in use, it is not very compact.

Moreover, the tripod legs 30 being connected at a predetermined angle makes the utilization of the conventional tripod arrangement on a non-flat surface infeasible because the limited degrees of movement for each leg prevents the tripod from effectively conforming to an irregular surface.

Therefore, it is desirable to provide a tripod arrangement that is compact.

It is further desirable to provide a tripod arrangement that includes a base being configured to enable a detachable leg to be attached at one of a plurality of angles, thereby enabling the tripod to effectively conform to an irregular surface.

### BRIEF DESCRIPTION OF THE DRAWINGS

The drawings are only for purposes of illustrating various embodiments and are not to be construed as limiting, wherein:

FIG. 1 shows a camera mounted on a tripod;

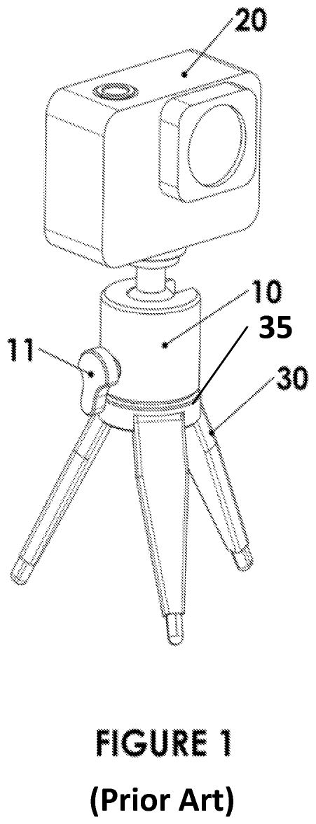

FIG. 2 shows a bottom view of a tripod base;

FIG. 3 shows a cut-away view of a leg attachment member for the tripod base of FIG. 2;

FIG. 4 shows a base attachment member for attaching a leg attachment module to the tripod base;

FIG. 5 illustrates another embodiment of a tripod base;

FIG. 6 shows a side view of a tripod base with a leg attachment module and tripod leg; and

FIG. 7 illustrates a leg attachment member with multiple tripod leg attachment sites.

### DISCLOSURE OF THE INVENTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

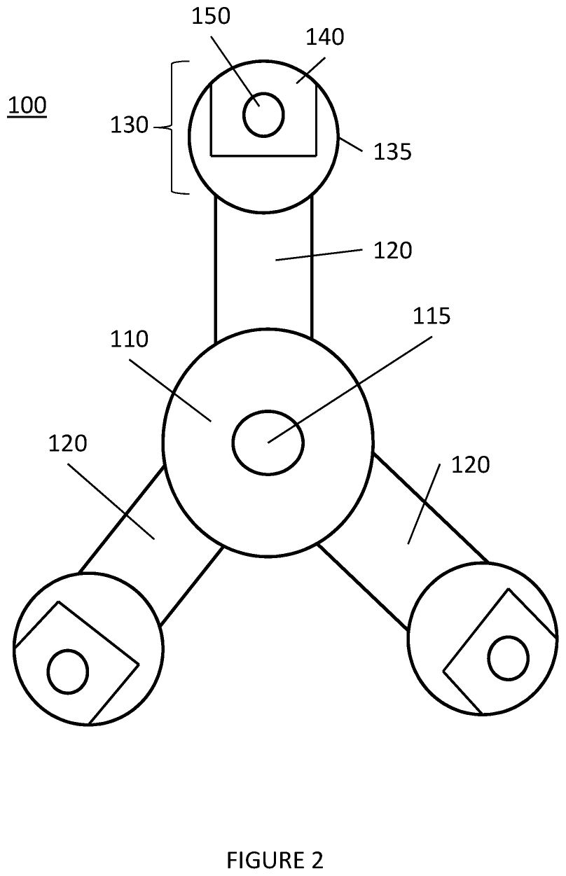

FIG. 2 shows a bottom view of a tripod supporting base. As illustrated in FIG. 2, a tripod base 100 includes a supporting base 110 with a connection interface 115. The connection interface 115 is configured to connect and interface with a device, such as a camera, etc. For example, the connection interface 115 is configured with threads to receive a threaded connection.

Extending from the supporting base 110, the tripod base 100 includes extension members 120. The extension members 120 may be detachable from the supporting base 110. The extension members 120 may extend outwardly from the supporting base 110 such that an angle between adjacent extension members is 120°.

At an end of each extension member 120, the tripod base 100 includes tripod leg attachment modules 130. Each tripod leg attachment module 130 includes a base attachment member 135, which connects the extension member 120 to a leg attachment member 140. The leg attachment member 140 includes a tripod leg attachment interface 150 for receiving a tripod leg (not shown).

It is noted that the extension members 120 may be telescopic to adjust the distance between the supporting base 110 and the tripod leg attachment modules 130.

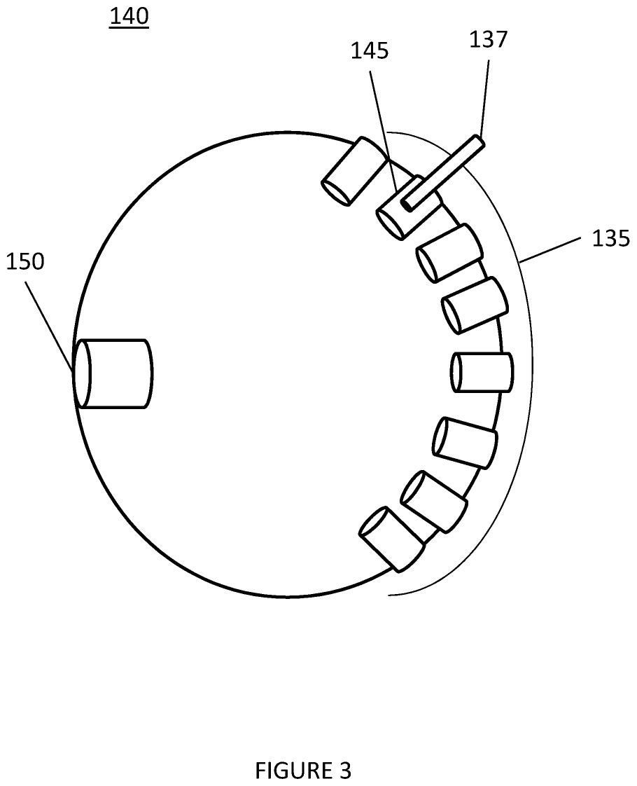

FIG. 3 shows a cut-away view of a leg attachment member for the tripod base of FIG. 2. As illustrated in FIG. 3, the leg attachment member 140 includes a tripod leg attachment interface 150 for receiving a tripod leg (not shown). The leg attachment member 140 also includes tripod leg positioning interfaces 145 configured to enable a tripod leg (not shown) to be rotated around such that the tripod leg can be positioned at various different distinct angles with respect to the tripod base 100.

As illustrated, the tripod leg positioning interfaces 145 are openings in the surface of leg attachment member 140 and may be configured to receive a locking mechanism 137; such as a pin, peg, rivet, screw, or bolt; from the base attachment member 135.

It is further noted that locking mechanism 137 may be a biased pin, peg, or rivet that is biased to an engagement position such that a user needs to pull the locking mechanism 137 outwardly, away from the tripod leg positioning interface 145, to disengage the tripod leg positioning interface so that the tripod leg can be rotated around to a new position with respect to the tripod base.

The leg attachment member 140 may be a spherical shape, as illustrated. However, the leg attachment member 140 may be any shape that enables the inclusion of multiple tripod leg attachment interfaces configured to enable a tripod leg to be rotated around such that the tripod leg can be positioned at various different distinct angles with respect to the tripod base 100.

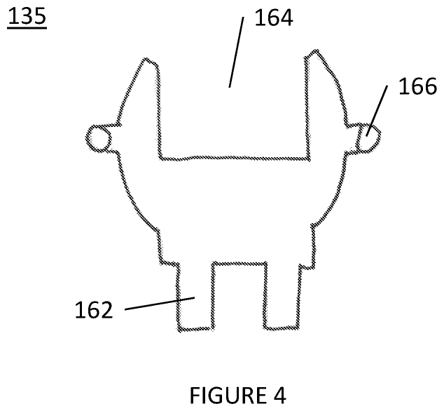

FIG. 4 shows a base attachment member for attaching a leg attachment module to the tripod base. As illustrated in FIG. 4, the base attachment member 135 includes an extension attachment interface 162 configured to connect the base attachment member 130 to the base. The extension attachment interface 162 may be an opening to receive a peg, rivet, or bolt. It is noted that the base (not shown) has a corresponding opening to receive the peg, rivet, or bolt. It is further noted that the opening may be threaded.

The base attachment member 135 includes a leg attachment member positioning interface 166 configured to lock a tripod leg (not shown) into a desired position by enabling the engagement of the leg attachment member with a locking mechanism (not shown), such as a pin, peg, rivet, screw, or bolt, which engage the tripod leg positioning interfaces. The tripod leg positioning interfaces may be an opening to receive a pin, peg, rivet, screw, or bolt. It is further noted that the opening may be threaded.

It is further noted that locking mechanism (not shown) may be a biased pin, peg, or rivet that is biased to an engagement position such that a user needs to pull the locking mechanism (not shown) outwardly, away from the leg attachment member positioning interface 166 to disengage the tripod leg positioning interface so that the tripod leg can be rotated around to a new position with respect to the tripod base.

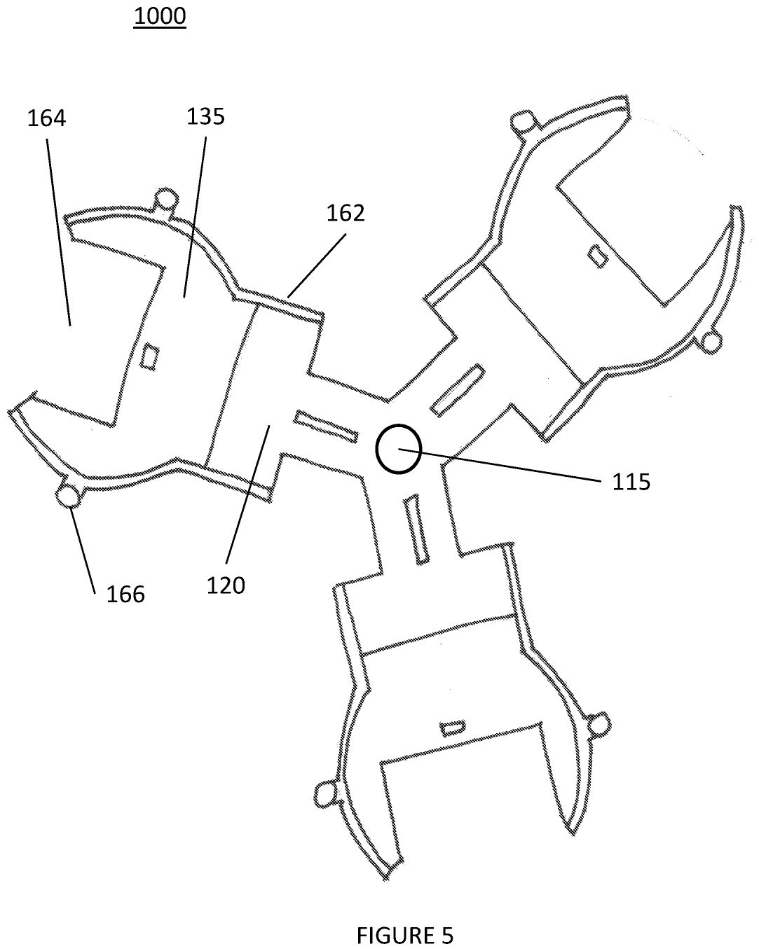

FIG. 5 illustrates another embodiment of a tripod base. As illustrated in FIG. 5, a tripod base 1000 includes a supporting base with a connection interface 115. The connection interface 115 is configured to connect and interface with a device, such as a camera, etc. For example, the connection interface 115 is configured with threads to receive a threaded connection.

The tripod base 1000 is configured to have extension members 120. The extension members 120 may be detachable from the supporting base. The extension members 120 may extend outwardly from the supporting base such that an angle between adjacent extension members is 120°.

At an end of each extension member 120, the tripod base 1000 includes tripod leg attachment modules. Each tripod leg attachment module includes a base attachment member 135, which connects the extension member 120 to a leg attachment member (not shown).

A tripod leg attachment module includes the base attachment member 135 and an extension attachment interface 162 configured to connect the base attachment member 135 to the base. The extension attachment interface 162 may be an opening to receive a peg, rivet, or bolt. It is noted that the base (not shown) has a corresponding opening to receive the peg, rivet, or bolt. It is further noted that the opening may be threaded.

The base attachment member 135 includes a leg attachment member positioning interface 166 configured to lock a tripod leg (not shown) into a desired position by enabling the engagement of the leg attachment member with a locking mechanism (not shown), such as a pin, peg, rivet, screw, or bolt, which engage the tripod leg positioning interfaces. The tripod leg positioning interfaces may be an opening to receive a pin, peg, rivet, screw, or bolt. It is further noted that the opening may be threaded.

It is further noted that locking mechanism (not shown) may be a biased pin, peg, or rivet that is biased to an engagement position such that a user needs to pull the locking mechanism (not shown) outwardly, away from the leg attachment member positioning interface 166 to disengage the tripod leg positioning interface so that the tripod leg can be rotated around to a new position with respect to the tripod base.

It is noted that the extension members 120 may be telescopic to adjust the distance between the base and the tripod leg attachment modules.

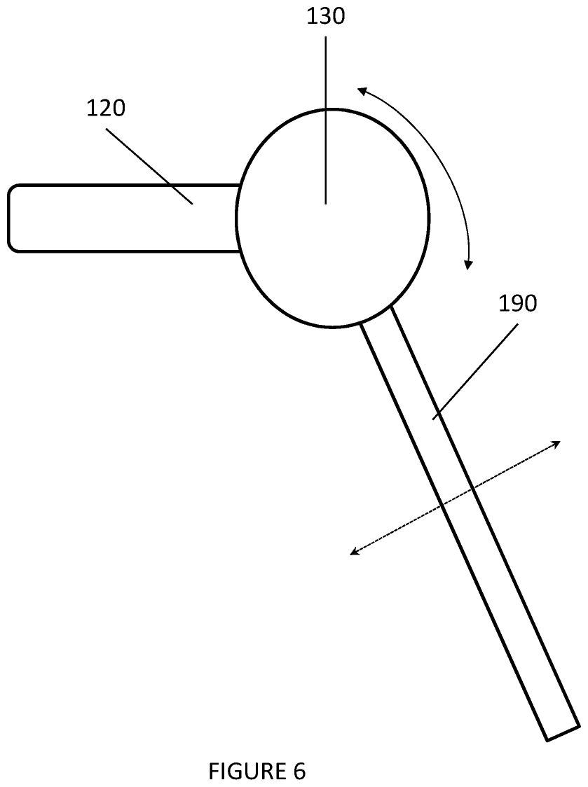

FIG. 6 shows a side view of a tripod base with a leg attachment module and tripod leg. As illustrated in FIG. 6, a tripod base includes an extension arm 120 connected to a leg attachment module 130. A tripod leg 190 can be connected to the tripod base via the leg attachment module 130. The leg attachment module 130 is configured to enable the tripod leg 190 to be connected at different angles so that the user can effectively orientate the tripod leg 190 to conform to the surface upon which the tripod is being placed. In other words, one tripod leg could be connected to one leg attachment module at a 120° angle and a second tripod leg could be connected to another leg attachment module at a 135° angle.

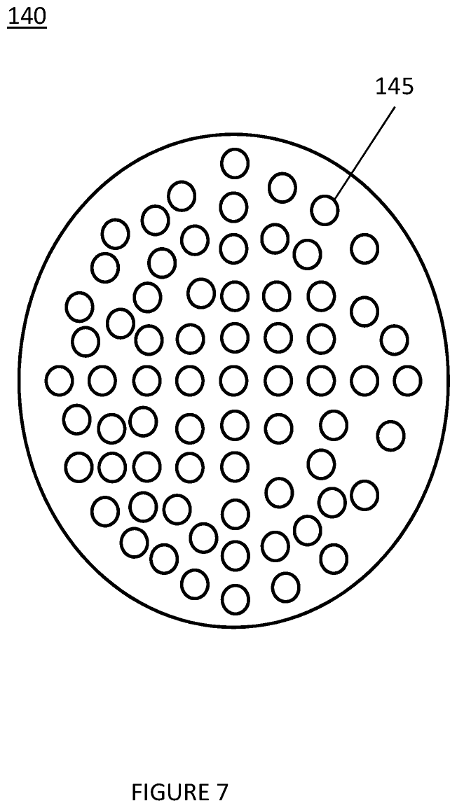

FIG. 7 illustrates a leg attachment member with multiple tripod leg attachment sites. As illustrated in FIG. 7, a leg attachment member 140 is a sphere having a tripod leg attachment interface (not shown) and multiple tripod leg attachment interfaces 145 located on the outer surface of the sphere opposite the tripod leg attachment interface. By being spherical in shape, the leg attachment member 140 enables the multiple tripod leg attachment interfaces 145 to create different angles for which the tripod leg can be positioned.

In the various embodiments described above, the tripod legs can be moved from side to side and also from top to bottom. The tripod legs may be configured to be detachable from the extension members. The extension members may also be configured to be detachable from the tripod base.

Also, in the various embodiments described above, the leg attachment member can be made of metal or synthetic material and be drilled with holes that allow the tripod legs to have various positions and also have a hole for the tripod leg to be attached thereto.

Further, in the various embodiments described above, each extension member may be configured to insert into the base with members to secure the extension member to the base.

Additionally, in the various embodiments described above, the leg attachment members are securely connected to the extension members. The leg attachment member has a tripod leg attachment interface so that the leg is attached thereto. On the other side of the leg attachment member multiple openings. The multiple openings covering about half of the leg attachment member's range, enabling the connected tripod leg to have a wide range of movement.

It is noted that the base and extension members may be permanently attached. It is further noted that the base and extension members may be permanently attached in a hinge configuration.

It is also noted that the leg attachment modules may be permanently attached to the extension members.

A tripod comprises a base; an extension member; and a tripod leg attachment member; the tripod leg attachment member including a tripod leg attachment interface configured to attach a tripod leg thereto and a plurality of tripod leg positioning interfaces configured to enable a tripod leg to be positioned at various different distinct angles with respect to the base.

The tripod may further comprise a base attachment member configured to connect the tripod leg attachment member to the extension member.

The base attachment member may include a locking mechanism configured to prevent movement of the tripod leg attachment member.

The tripod leg attachment member may be detachably connected to the base attachment member.

The extension member may be detachably connected to the base attachment member.

The locking mechanism may be configured to be biased in an engagement state with the tripod leg attachment member.

The extension member may be detachably connected to the base.

The tripod leg attachment member may be rotatable.

The base attachment member may be rotatably connected to the tripod leg attachment member and statically connected to the extension member.

A tripod comprises a base; an extension member; a tripod leg attachment member; and a tripod leg; the tripod leg attachment member including a tripod leg attachment interface configured to attach the tripod leg thereto and a plurality of tripod leg positioning interfaces configured to enable the tripod leg to be positioned at various different distinct angles with respect to the base.

The tripod may further comprise a base attachment member configured to connect the tripod leg attachment member to the extension member.

The base attachment member may include a locking mechanism configured to prevent movement of the tripod leg attachment member.

The tripod leg attachment member may be detachably connected to the base attachment member.

The extension member may be detachably connected to the base attachment member.

The locking mechanism may be configured to be biased in an engagement state with the tripod leg attachment member.

The extension member may be detachably connected to the base.

The tripod leg attachment member may be rotatable.

The base attachment member may be rotatably connected to the tripod leg attachment member and statically connected to the extension member.

It will be appreciated that the above-disclosed embodiment and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. A tripod comprising:
a base;
an extension member; and
a tripod leg attachment member;
said tripod leg attachment member including,
a tripod leg attachment interface configured to attach a tripod leg thereto, and
a plurality of tripod leg positioning interfaces configured to enable a tripod leg to be positioned at various different distinct angles with respect to said base.

2. The tripod, as claimed in claim 1, further comprising:
a base attachment member configured to connect said tripod leg attachment member to said extension member.

3. The tripod, as claimed in claim 2, wherein said base attachment member includes a locking mechanism configured to prevent movement of said tripod leg attachment member.

4. The tripod, as claimed in claim 2, wherein said tripod leg attachment member is detachably connected to said base attachment member.

5. The tripod, as claimed in claim 2, wherein said extension member is detachably connected to said base attachment member.

6. The tripod, as claimed in claim 4, wherein said extension member is detachably connected to said base attachment member.

7. The tripod, as claimed in claim 3, wherein said locking mechanism is configured to be biased in an engagement state with said tripod leg attachment member.

8. The tripod, as claimed in claim 1, wherein said extension member is detachably connected to said base.

9. The tripod, as claimed in claim 1, wherein said tripod leg attachment member is rotatable.

10. The tripod, as claimed in claim 2, wherein said base attachment member is rotatably connected to said tripod leg attachment member and statically connected to said extension member.

11. A tripod comprising:
a base;
an extension member;
a tripod leg attachment member; and
a tripod leg;
said tripod leg attachment member including,
a tripod leg attachment interface configured to attach said tripod leg thereto, and
a plurality of tripod leg positioning interfaces configured to enable said tripod leg to be positioned at various different distinct angles with respect to said base.

12. The tripod, as claimed in claim 11, further comprising:
a base attachment member configured to connect said tripod leg attachment member to said extension member.

13. The tripod, as claimed in claim 12, wherein said base attachment member includes a locking mechanism configured to prevent movement of said tripod leg attachment member.

14. The tripod, as claimed in claim 12, wherein said tripod leg attachment member is detachably connected to said base attachment member.

15. The tripod, as claimed in claim 12, wherein said extension member is detachably connected to said base attachment member.

16. The tripod, as claimed in claim 14, wherein said extension member is detachably connected to said base attachment member.

17. The tripod, as claimed in claim 13, wherein said locking mechanism is configured to be biased in an engagement state with said tripod leg attachment member.

18. The tripod, as claimed in claim 11, wherein said extension member is detachably connected to said base.

19. The tripod, as claimed in claim 11, wherein said tripod leg attachment member is rotatable.

20. The tripod, as claimed in claim 12, wherein said base attachment member is rotatably connected to said tripod leg attachment member and statically connected to said extension member.
